(19) United States
(12) Patent Application Publication
(10) Pub. No.: US 2008/0290114 A1
(43) Pub. Date: Nov. 27, 2008

(54) Drug Delivery Flow Controller

(75) Inventors: Eugen I. Cabuz, Eden Prairie, MN (US); Jay G. Schwichtenberg, New Hope, MN (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL INC., Morristown, NJ (US)

(21) Appl. No.: 11/754,138

(22) Filed: May 25, 2007

(51) Int. Cl. B67D 5/16

(52) U.S. Cl. 222/56

(57) ABSTRACT

A drug delivery system for delivering a fluid to a desired location within a body that uses two control loops to control fluid flow: a first control loop in which a pressure source moves the fluid at an approximate rate, and a second control loop where a variable impedance mechanism more precisely controls the flow rate. After the fluid has moved through the chambers of these two control loops, a flow sensor measures the flow rate, sends the flow rate information to the control electronics, which then adjusts the pressure and impedance in a closed-loop manner to maintain a constant, desired flow rate. The drug delivery device may be used in portable or wearable mechanisms.

### FIELD

The present invention relates generally to drug delivery. More particularly, the present invention relates to fluid driving systems for portable drug delivery devices.

### BACKGROUND

Drug therapies are a primary component of an overall patient health plan. Oral tablets and patches are an available means for many drugs, but some drug treatments, such as protein-containing drugs like insulin, cannot be administered in this fashion. Since insulin is a protein which is readily degraded in the gastrointestinal tract, those in need of the administration of insulin administer the drug by subcutaneous injection. In addition, there are many other occasions where liquids, such as blood, saline solution, or water, must be injected into the body.

Drug delivery using current drug delivery devices can be problematic in that certain issues, such as control of the fluid flow rate of the drug being administered, need to be addressed. For example, in applications such as delivery of the drug insulin into a diabetic patient's body, it is desirable to mimic the function of a normally operating pancreas; the ability to more precisely control the flow rate of insulin would enable that objective. A number of flow-regulators have been proposed for the purpose of controlling the fluid flow rate, but the known regulators have not proved satisfactory with respect to the precision and the compactness of the drug delivery device. Conventional drug delivery devices attempt to control flow by using so-called volume controlled flow. Volume-controlled flow is an open-loop system that generates precision pressures by driving precision pumps such as syringe pumps with stepper motors. In these open-loop systems, there is no measurement of the rate of fluid flow and no subsequent use of that measurement as feedback to change the actual flow rate to conform to a desired flow rate.

The ability to measure fluid flow and change the flow rate based on the feedback of the measurement would not only allow for more effective dosing to patients, it would increase the safety of drug delivery as well. Given the fact that drug chamber pressure is above body pressure, there remains a remote possibility for an overdose of drug due to component failure, allowing for excess fluid flow into the body. Although adding backup mechanisms could decrease the risk of excess fluid flow due to component failure, there remains some risk of multiple component failure which could result in overdosing. Depending on the type of drug being administered, such overdosing could potentially be fatal. If a drug delivery device could more precisely measure the fluid flow rate, a large excess of fluid flow could quickly be detected.

There is a need for a drug delivery system for administering drug therapies that can measure the actual flow rate of a fluid, and use that measurement to change the flow rate, obtaining precise control over the fluid flow of the drug being administered.

### SUMMARY

The present invention overcomes many of the disadvantages of the prior art by providing a drug delivery device that remains compact and wearable, yet maintains a more precise control over the flow rate than conventional systems. This is preferably achieved using two control loops, a pressure control loop and a variable impedance control loop, in a closed loop system. Such a drug delivery device may help improve healthcare of patients by providing a fluid flow that is able to conform more accurately to the desired flow rate. In the case of the delivery of insulin to diabetes patients, for example, a more precise fluid flow rate and the ability to measure and adapt the rate accordingly may allow for the drug delivery device to more accurately mimic a normally functioning pancreas.

For purposes of this disclosure, the term “drug” means any type of molecules or compounds deliverable to a patient to include being deliverable as a fluid, slurry, or fluid-like manner. The term “drug” is also defined as meaning any type of therapeutic agent/diagnostic agent which can include any type of medicament, pharmaceutical, chemical compounds, dyes, biological molecules to include tissue, cells, proteins, peptides, hormones, signaling molecules or nucleic acids such as DNA or RNA.

As previously stated, the present invention uses a pressure control loop and a variable impedance control loop; both are controlled by a closed loop feedback path. In one illustrative example, the pressure control loop and variable impedance control loop are electronically powered. The pressure control loop is powered by a stepper motor, which is coupled to a removable cartridge that contains a reservoir of fluid. The stepper motor uses a piston to apply pressure to a removable cartridge that contains a reservoir of fluid, increasing the pressure in the removable cartridge. Once the pressure has built, the fluid exits the reservoir, flowing through a chamber and a tube to an outlet. To further control the rate of the fluid before the fluid exits through the outlet, the variable impedance control loop, also powered by a stepper motor, inserts a wire into the tube to provide an impedance to fluid flow. The fluid then exits the tube and flows through a flow sensor and into the body of a patient.

The flow sensor measures the fluid flow rate (“measured flow rate”), and sends output signals regarding the measured flow rate to the control electronics, which receives the signals. The control electronics compares the measured flow rate to a pre-programmed or user-input desired flow rate, and adjusts the appropriate stepper motor to conform the measured flow rate to the desired flow rate.

The range of control requested by a drug delivery, such as insulin, is very large, the maximum/minimum flow ratio being approximately 1000. This large range can be controlled using the two control loops, each in charge with the control of a flow ratio of approximately 30.

The miniaturized portable drug delivery system may be provided in a housing sufficiently small to be appropriately and comfortably “wearable” on a person. In one illustrative example of the invention, the housing is sized similar to a personal digital assistant. The wearable housing may include, for example, a base, cover, and hinge that secures the base to the cover.

### BRIEF DESCRIPTION OF THE DRAWINGS

Various embodiments are described herein with reference to the following drawings. Certain aspects of the drawings are depicted in a simplified way for reason of clarity. Not all alternatives and options are shown in the drawings and, therefore, the invention is not limited in scope to the content of the drawings. In the drawings:

FIG. 1 is a perspective view of the preferred portable drug delivery device;

FIG. 2 is a schematic view of the drug delivery device of FIG. 1, at the initial start-up phase;

FIG. 3 is a schematic view of the drug delivery device operating at maximum flow;

FIG. 4 is a schematic view of the drug delivery device operating with an impedance control restricting the flow of fluid; and

FIG. 5 is a schematic view of the drug delivery device in the re-charging phase, with a valve open for air intake.

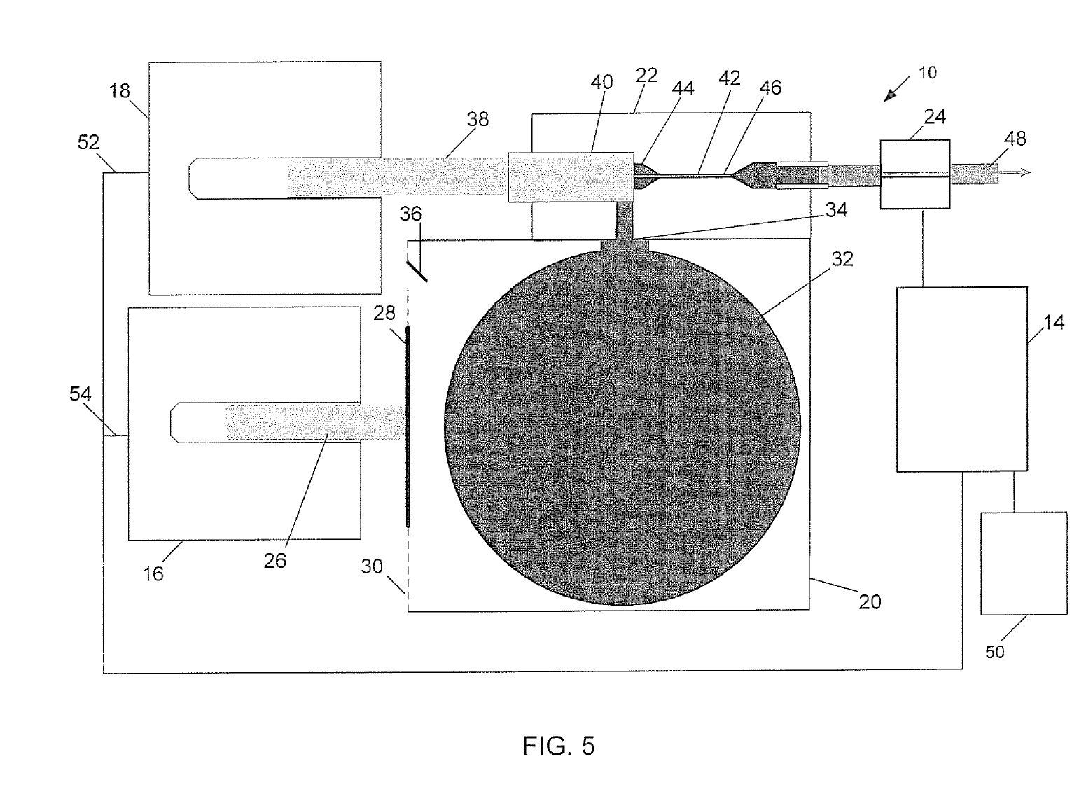

### DETAILED DESCRIPTION

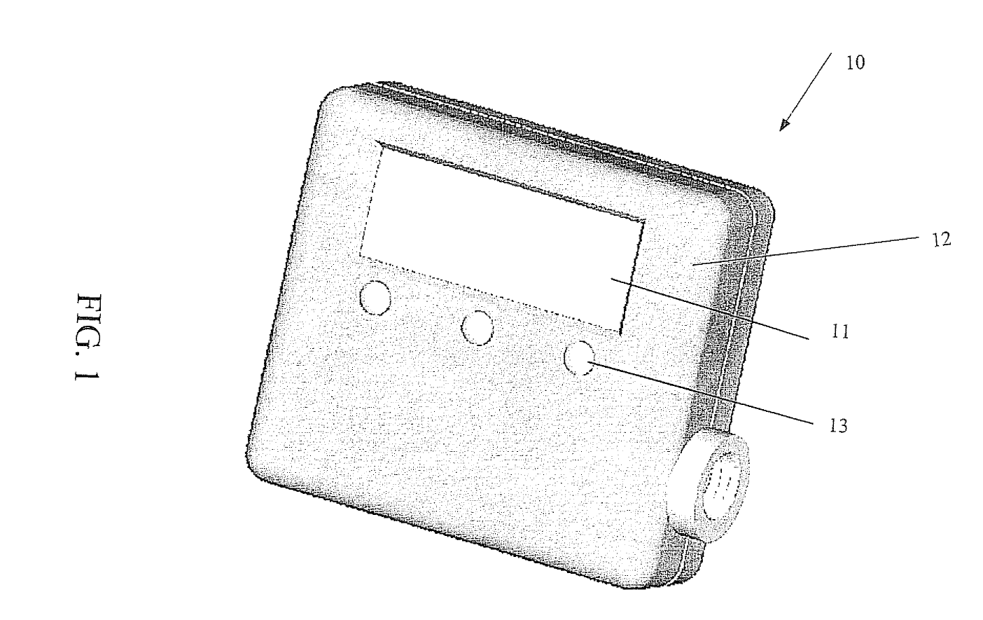

FIG. 1 is a perspective view of an illustrative portable drug delivery device in accordance with the present invention. The drug delivery device is generally shown at 10, and includes a display screen 11, a housing 12, and user input buttons 13. Preferably, drug delivery device 10 is approximately 35 mm by 40 mm; however, the device is not limited to these dimensions. The display screen 11 and user input buttons 13 comprise a configuration interface, wherein a user may navigate through a menu shown on display screen 11, and introduce the profile rate of the flow needed for the particular drug delivery application. Although three user input buttons 13 are shown in FIG. 1, the device is not limited to three user input buttons, and other numbers of user input buttons 13 may be used.

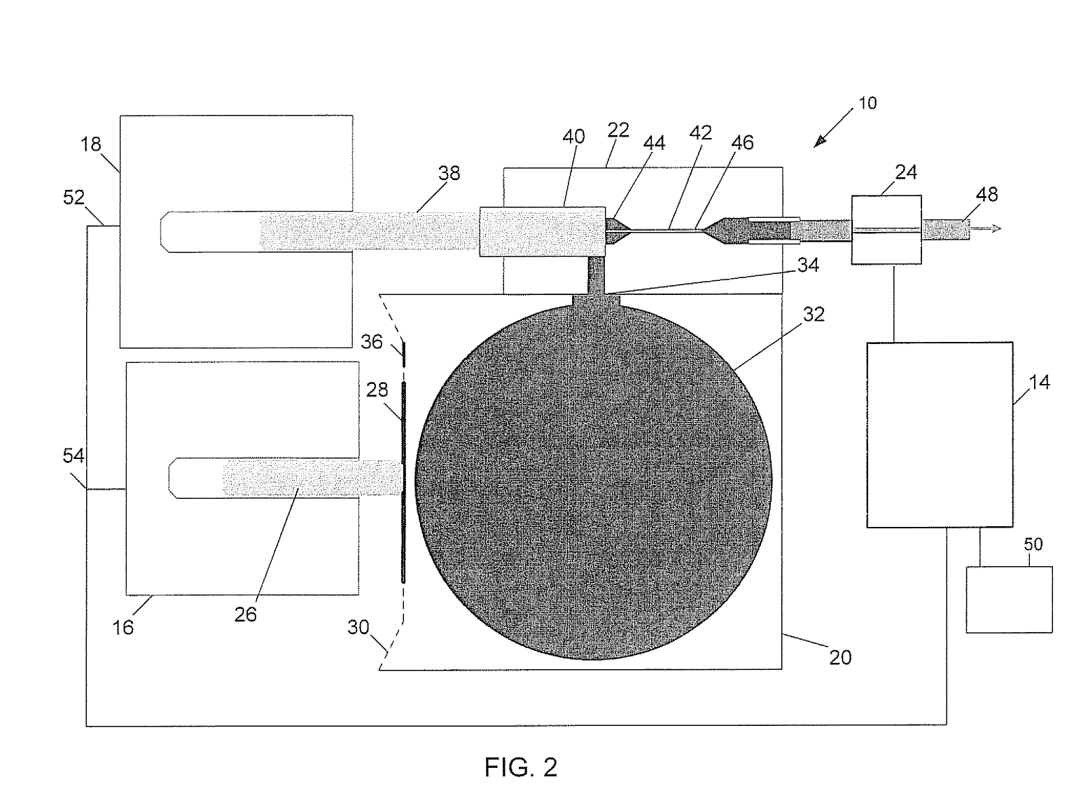

FIG. 2 is a schematic view of the drug delivery device 10 of FIG. 1, and includes control electronics 14, a first stepper motor 16, a second stepper motor 18, a removable or replaceable cartridge 20, a container 22, and a flow sensor 24.

The first stepper motor 16 includes a first piston 26. The removable cartridge 20 includes a rigid wall 28, a flexible wall 30, a reservoir 32, an aperture 34, and a valve 36. The reservoir 32 is preferably filled with a fluid before removable cartridge 20 is shipped for use in drug delivery device 10. Second stepper motor 18 includes a second piston 38, a block 40, and a wire 42. Container 22 includes a chamber 44, a tube 46, and an outlet 48.

Drug delivery device 10 may also include a battery 50 for powering the device. Preferably, battery 50 is a single AA battery; alternatively, battery 50 may be one or a plurality of batteries of varying types.

Control electronics 14 includes a controller or processor that is able to receive and process output signals, as well as control and power motors in accordance with the signals received.

Preferably, both first stepper motor 16 and second stepper motor 18 are light weight, low power, compact, high precision motors. It is desirable to have very small motors for this application. First stepper motor 16 may be the same motor as second stepper motor 18. Alternatively, first stepper motor 16 may be a different motor from second stepper motor 18.

Flow sensor 24 is preferably a high-performance, liquid nano-flow sensor. The primary features of this sensor are high accuracy, high sensitivity, wide dynamic range, automatic temperature and viscosity compensation, small package size and analog signal output. The Honeywell X119177 flow sensor is a suitable flow sensor for this drug delivery device; the flow sensor can measure very small flow rates, from 5 nL/min to 5 uL/min.

For ease of manufacture, rigid wall 28 may be made from another rigid material used on drug delivery device 10. As an example material, rigid wall 28 may be made from a polycarbonate. Flexible wall 30 may be made from an elastomeric material. In the alternative, flexible wall 30 may be the same material as removable cartridge 20. As an example, removable cartridge 20 may be made from a deformable polycarbonate, allowing for any wall to be flexible wall 30.

Valve 36 may be a passive valve; that is, the valve opens due to the removal of pressure from removable cartridge 20, and closes when the pressure increases. Alternatively, valve 36 may be an active valve, such as an electrostatic valve, that is controlled by control electronics 14, and can be opened or closed electronically. An active valve may be desired when more power is required to open valve 36. Additionally, if valve 36 is an active valve, control electronics 14 may be programmed to open valve 36 when the rate of the fluid drops below a predetermined value. When the pressure drops too low to initiate fluid flow, valve 36 is opened to replenish air supply into removable cartridge 20. Control electronics 14 is then re-started. The re-start process, however, would only take a matter of seconds.

In the portable drug delivery device 10, the removable cartridge 20 is removably affixed to first piston 26. Rigid wall 28 of the replaceable cartridge 20 may be affixed to first piston 26 with a screw. Although rigid wall 28 and second stepper motor 18 are shown on the side of the cartridge opposite control electronics 14, rigid wall 28 and second stepper motor 18 may be located on the same side as control electronics 14. In fact, rigid wall 28 and second stepper motor 18 may be located on any side of removable cartridge 20, as long as first piston 26 is able to push rigid wall 28, and increase the pressure. Control electronics 14 is connected to first stepper motor 16. Control electronics 14 may be connected to the first stepper motor 16 with a wire, so that they are in electronic communication. Control electronics 14 is also connected to second stepper motor 18. Control electronics 14 may be connected to the second stepper motor 18 with a wire, so that they are in electronic communication. Aperture 34 connects reservoir 32 to chamber 44. Tube 46 connects chamber 44 to flow sensor 24. Flow sensor 24 is connected to and is in electronic communication with control electronics 14.

To initiate drug delivery, removable cartridge 20 is inserted into drug delivery device 10. Rigid wall 28 is then affixed to first piston 26 with a screw. To pressurize the system as shown in FIG. 2, control electronics 14 powers second stepper motor 18 to push block 40 and wire 42 into chamber 44, so that block 40 completely blocks aperture 34 and there is zero fluid flow into chamber 44. Control electronics 14 then powers first stepper motor 16, pushing first piston 26 toward rigid wall 28. First piston 26 makes contact with rigid wall 28, and then continues to push against rigid wall 28. As rigid wall 28 is pushed toward reservoir 32, flexible wall 30 depresses, applying pressure to reservoir 32. As the pressure increases, valve 36 closes to prevent air seepage out of removable cartridge 20. Once reservoir 32 is properly pressurized, control electronics powers second stepper motor 18 to remove block 40 from aperture 34, allowing fluid to flow into chamber 44.

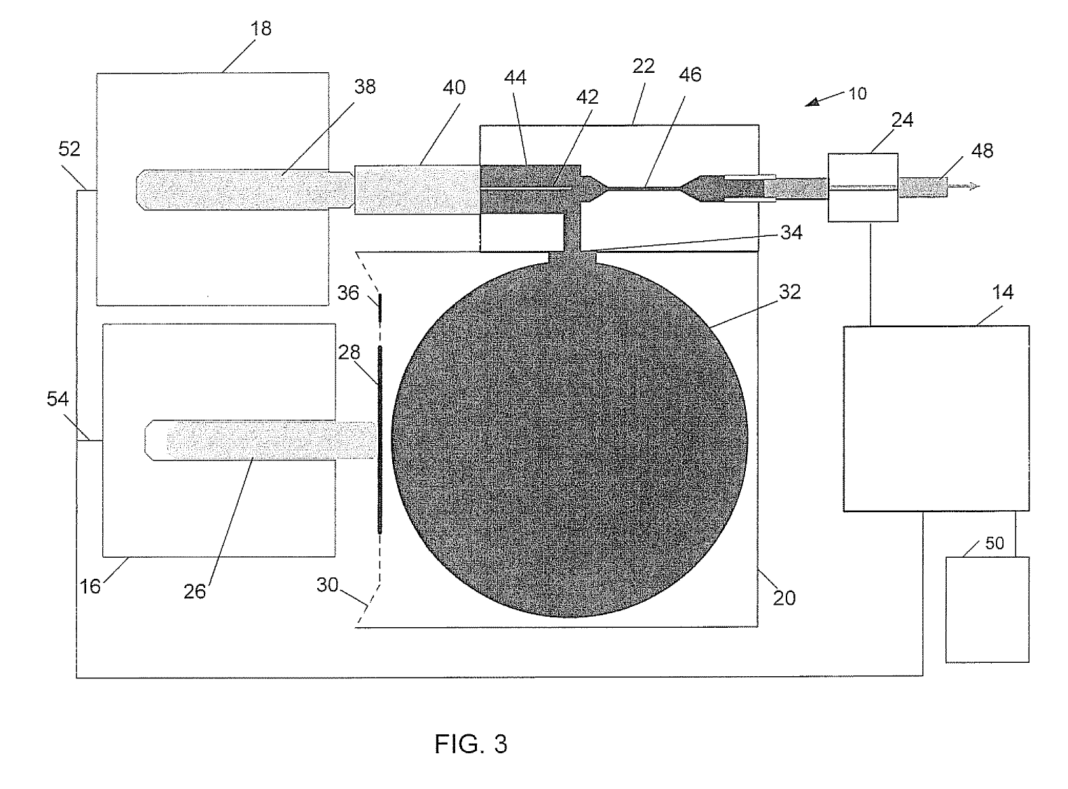

FIG. 3 is a schematic view of drug delivery device 10 operating at maximum flow. Once sufficient pressure has been built in the removable cartridge, control electronics 14 causes second stepper motor 18 to pull block 40 back, uncovering aperture 34, as shown in FIG. 3. Once aperture 34 is uncovered, it is in fluid communication with chamber 44, and the fluid exits reservoir 32 via aperture 34, flowing into chamber 44. The fluid then continues to flow through tube 46, through outlet 48, and into the body of the patient. Flow sensor 24 is provided in-line with the fluid prior to delivery into the body. Flow sensor 24 measures the rate of fluid flow. An output signal from flow sensor 24 is provided to control electronics 14. Control electronics 14 receives the output signals from flow sensor 24.

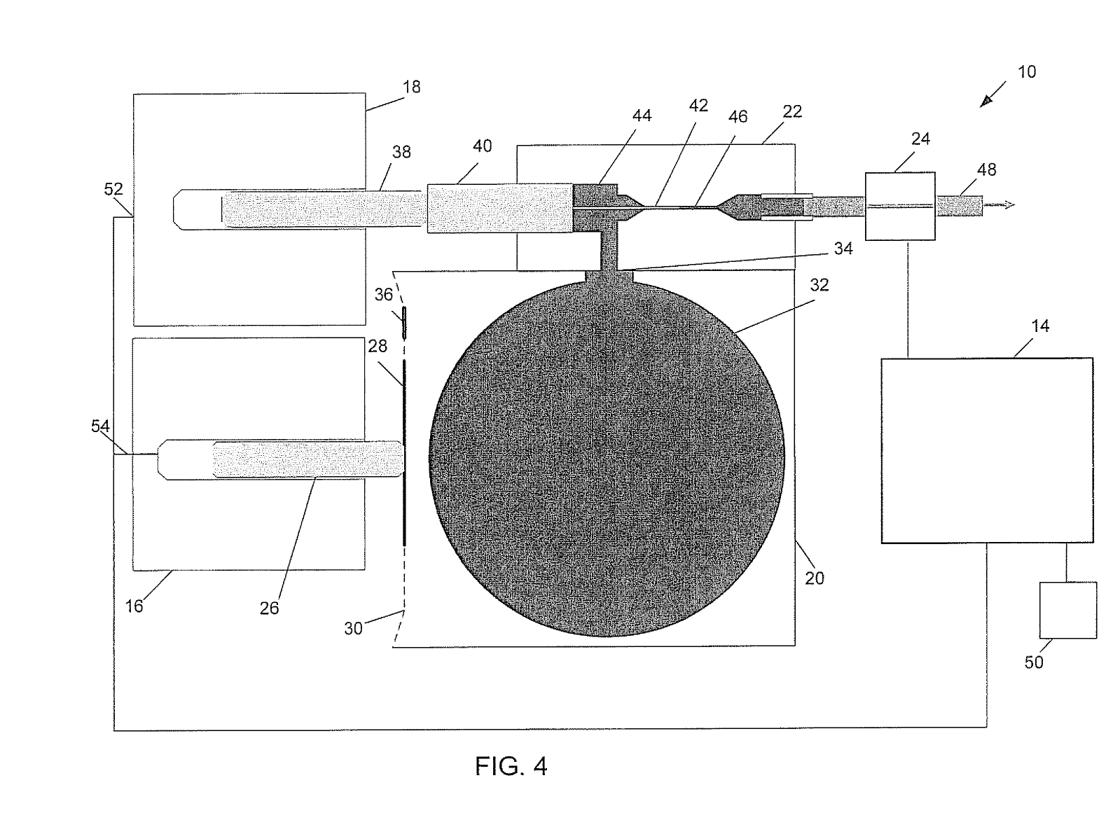

FIG. 4 is a schematic view of an illustrative drug delivery device during operation, using a variable impedance loop 52 to control the fluid flow rate. After control electronics 14 receives the output signals from flow sensor 24, control electronics 14 may compare the measured rate of the flow with a desired rate. The desired rate may be a pre-programmed rate. In the alternative, the desired rate may be manually entered by a user. As an example, for use as a drug delivery device to deliver insulin to a diabetes patient, it is desirable to mimic the function of the pancreas, and thus control electronics 14 may be pre-programmed to increase or decrease the flow rate of insulin into a patient at specific, pre-determined times of the day, to mimic a normally functioning pancreas. However, if an emergency arises, in which the patient requires an immediate dosage of insulin that was not part of the pre-programmed fluid flow, a separate input access may be available on control electronics 14 for a user to manually input a desired rate. An LCD display may be connected to control electronics 14 to display the fluid flow rate and include a user input.

If the fluid's measured rate does not match the desired rate, control electronics 14 may adjust either first stepper motor 16 or second stepper motor 18, or both, to attain the desired rate.

Control electronics 14, first stepper motor 16, first piston 26, and flow sensor 24 comprise pressure control loop 52. Control electronics 14 controls pressure control loop 54 by powering first stepper motor 16 to increase or decrease the pressure applied to removable cartridge 20 by either pushing first piston 26 against rigid wall 28, or not pushing piston 26 against rigid wall 28. As the pressure is increased, the flow rate of the fluid through aperture 34 is increased.

Control electronics 14, second stepper motor 18, second piston 38, block 40, wire 44, tube 46, and flow sensor 24 comprise variable impedance loop 52. Variable impedance loop 52 is able to control fluid flow very precisely, due to the impedance determined by tube 46 and wire 42. FIG. 4 illustrates variable impedance loop 52 in operation. In FIG. 4, as fluid flows through chamber 44 and into tube 46, second stepper motor 18 pushes wire 42 into tube 46 by a distance [symbol] , thus impeding the flow of fluid through tube 46. The impedance section of wire 42 inside tube 46 is determined by the equation:

Impedance˜ [symbol] *[(Π(radius tube)²)−(Π(radius wire)²)]

The total impedance of the flow in the tube is defined by the summation of the impedance of the section of tube 46 with wire 42 inserted and the impedance of the section of tube 46 without the insertion of wire 42.

The maximum flow rate occurs when wire 42 is completely removed from tube 46 and the pressure applied to reservoir 32 is at a maximum.

Tube 46 preferably has a diameter in the range of 6-8 mils (a mil being a unit of length equal to 0.0254 millimeters), and wire 42 is preferably in the range of 4-6 mils; however, other values outside of those ranges may be possible. The preferred embodiment uses an approximate 0.5 mil to 1 mil difference between the diameter of tube 46 and wire 42. Wire 42 is preferably made from a material strong enough so that it will not be damaged from the force of fluid flow.

By increasing or decreasing length [symbol] , second stepper motor 18 is able to precisely control the flow rate. After exiting tube 46, flow sensor 24 measures the flow rate, sends the flow rate as an output signal to control electronics 14, which may then fine-tune the rate of the flow by further adjusting first stepper motor 16 and second stepper motor 18. This closed loop system provides feedback to control electronics 14 and uses that feedback to adjust the flow rate using both a pressure control loop and a variable impedance control loop.

If a large enough quantity of air seeps out of removable cartridge 20, there will not be enough air inside removable cartridge 20 for sufficient pressure to maintain the desired flow of fluid through the system. In this case, as shown in FIG. 4, control electronics 14 will stop first stepper motor 16 from pushing first piston 26 into rigid wall 28, allowing valve 36 to open. Valve 36 opens to allow for sufficient air intake to re-pressurize fluid reservoir, so that the drug delivery process may begin anew. Control electronics 14 then re-starts, and the drug delivery device 10 returns to the initiation phase as described in FIG. 1.

Although the invention has been described in detail with particular reference to a preferred embodiment, other embodiments can achieve the same results. Variations and modifications of the present invention will be obvious to those skilled in the art and it is intended to cover in the appended claims all such modifications and equivalents. The entire disclosures of all references, applications, patents, and publications cited above, are hereby incorporated by reference.

We claim:

1. A device for delivering a drug to an outlet comprising:
a reservoir, configured for storing and supplying a fluid at a pressure above atmospheric pressure;
a flow path in fluid communication with the reservoir and the outlet, said flow path including:
an aperture that permits fluid flow to exit the reservoir;
a chamber; and
a tube;
a first stepper motor that operates a moving element to change the reservoir pressure, causing the fluid to exit the reservoir;
a second stepper motor that operates the insertion of a wire into the tube, restricting fluid flow along the flow path;
a flow sensor deployed at a point along the flow path and electronically associated with the control electronics, wherein the flow sensor measures the flow rate at the point and outputs the flow rate to the control electronics; and
control electronics electronically associated with the flow sensor, the first stepper motor and the second stepper motor, and configured to receive the outputted flow rate from the flow sensor, compare the received flow rate with a desired flow rate, and selectively power the first and second stepper motors to deliver the desired flow rate of fluid to the outlet.

2. The device as in claim 1, wherein the moving element is a piston pushing on a wall of a cartridge, and wherein the cartridge comprises the reservoir.

3. The device as in claim 2, wherein a valve is located on a wall of the cartridge, to allow for air intake into the cartridge.

4. The device as in claim 3, wherein the valve is a passive valve.

5. The device as in claim 3, wherein the valve is an active valve controlled by the control electronics.

6. The device as in claim 1, wherein the device for delivering a drug is wearable.

7. The device as in claim 1, wherein the reservoir is contained within a cartridge.

8. The device as in claim 7, wherein the cartridge is removable.

9. The device as in claim 1, wherein the control electronics comprises a user input, allowing for a user to manually input the desired flow rate.

10. A device for delivering a drug to an outlet comprising:
a reservoir, configured for storing and supplying a fluid at a pressure above atmospheric pressure;
a flow path in fluid communication with the reservoir and the outlet, said flow path including:
an aperture that permits fluid flow to exit the reservoir;
a chamber;
a tube;
control electronics;
a pressure control loop, wherein the control electronics powers a moving element to change the reservoir pressure, causing the fluid to exit the reservoir at a flow rate;
a variable impedance loop, wherein the control electronics powers the insertion of a wire into the tube, limiting fluid flow along the flow path; and
a flow sensor deployed at a point along the flow path and electronically associated with the control electronics, wherein the flow sensor measures the flow rate at the point and outputs the flow rate to the control electronics.

11. The device of claim 10, wherein the variable impedance loop uses a stepper motor attached to the wire to insert the wire into the tube.

12. The device of claim 10, wherein the moving element of the pressure control loop comprises a stepper motor with a piston.

13. The device of claim 10, wherein the reservoir is located within a cartridge.

14. The device of claim 13, wherein the cartridge is removable.

15. The device of claim 13, wherein the cartridge comprises a valve, to allow for air intake into the cartridge.

16. The device as in claim 1, wherein control electronics comprises a user input, allowing for a user to manually input the desired flow rate.

17. The device as in claim 10, wherein the device is wearable.

18. The device as in claim 10, wherein the variable impedance loop comprises a closed-loop system.

19. The device as in claim 10, wherein the pressure control loop comprises a closed-loop system.

20. A method for delivering precise fluid flow control, comprising:
pressurizing a reservoir, wherein the reservoir includes a fluid;
measuring a rate of fluid flow; and
controlling an impedance to the fluid flow, wherein the controlling is based on the measured rate of fluid flow.
